(19) United States
(12) Patent Application Publication
(10) Pub. No.: US 2005/0066821 A1
(43) Pub. Date: Mar. 31, 2005

(54) Residue container

(76) Inventor: Rainer Helfrich, Grafelfing (DE)

Correspondence Address: MURAMATSU & ASSOCIATES, Suite 225, 7700 Irvine Center Drive, Irvine, CA, 92618, US

(21) Appl. No.: 10/895,763

(22) Filed: Jul. 21, 2004

(30) Foreign Application Priority Data
Jul. 22, 2003 (DE) 203 11 272.5

(51) Int. Cl. A47J 31/00

(52) U.S. Cl. 99/279

(57) ABSTRACT

The invention relates to a residue container for a coffee machine, the container having an insert of absorbent material for absorbing the moisture contained in the coffee grounds.

### FIELD OF THE INVENTION

This invention relates to a residue container for a coffee machine.

### BACKGROUND OF THE INVENTION

High quality coffee or espresso machines are now very popular in private households too. Such machines generally have a so-called residue or coffee grounds container for the coffee grounds. Coffee grounds are introduced into that container after the infusion process, and they settle and adhere there owing to the moisture present. If the coffee grounds remain in the container for too long a period, mould is formed, which makes cleaning even more time consuming.

The machine manufacturers are aware of this problem. They therefore recommend the daily disposal of any material that remains and the cleaning of the residue container. If, however, the daily cleaning is forgotten, the mould may spread to the entire machine. The result is that normal cleaning is no longer sufficient and the entire machine has to be serviced at great expense.

### SUMMARY OF THE INVENTION

The object of the invention is therefore to provide a means whereby mould formation is prevented and the disposal of the coffee grounds is facilitated.

According to the invention, this object is achieved by the features recited in the claims in that the residue container for a coffee machine has an insert of absorbent material for absorbing the fluid contained in the coffee grounds. That measure largely prevents the formation of mould. If the insert is disposed of together with the coffee grounds, particularly easy and rapid cleaning results.

A further advantage also resides in the fact that the residue container can have a larger structure overall because the insert according to the invention largely prevents mould formation and, as a result, cleaning is now necessary only at relatively long time intervals.

Further forms of the invention are the subject matter of the subordinate claims.

According to a particular form of the invention, the insert is folded from a flat material blank, perforation lines or the like advantageously predetermining the folding edges.

In a special form, the insert is constructed in the manner of a bag, it being possible for the insert to have carrying elements, such as handles. According to a further embodiment, the insert is so constructed and arranged that at least one cavity is formed between the insert and the container. As a result, the drying of the insert is promoted and mould formation is prevented.

Further forms and advantages of the invention are explained in more detail hereinafter by means of the description of some embodiments and the drawings.

### BRIEF DESCRIPTION OF THE DRAWINGS

FIG. 1 is a diagrammatic representation of an insert which lines the residue container completely.

FIG. 2 is a diagrammatic representation of an insert which lines the residue container partially.

FIG. 3 is a diagrammatic representation of an insert having inclined walls.

FIG. 4 is a diagrammatic representation of an insert having inclined side walls of different heights.

FIG. 5 is a diagrammatic representation of an insert having a suspension flap and side walls of different heights.

FIG. 6 is a diagrammatic representation of an insert having three side walls and one suspension flap.

FIG. 7 is a diagrammatic representation of an insert having an auxiliary insert.

FIG. 8 is a diagrammatic representation of an insert having a pyramid like base according to a first embodiment.

FIG. 9 is a diagrammatic representation of an insert having a pyramid like base according to a second embodiment.

FIG. 10 is a diagrammatic representation of an insert having a pyramid like base according to a third embodiment.

FIG. 11 is a diagrammatic representation of an insert having four suspension flaps.

FIGS. 12-15 are diagrammatic representations of inserts having different carrying elements in the form of handles.

FIG. 16 is a diagrammatic representation of a flat material blank for an insert.

FIG. 17 is a diagrammatic representation of the folded insert according to FIG. 16.

FIG. 18 is a diagrammatic representation of a flat material blank according to a second embodiment.

FIG. 19 is a diagrammatic representation of a flat material blank according to a third embodiment.

### DETAILED DESCRIPTION OF THE INVENTION

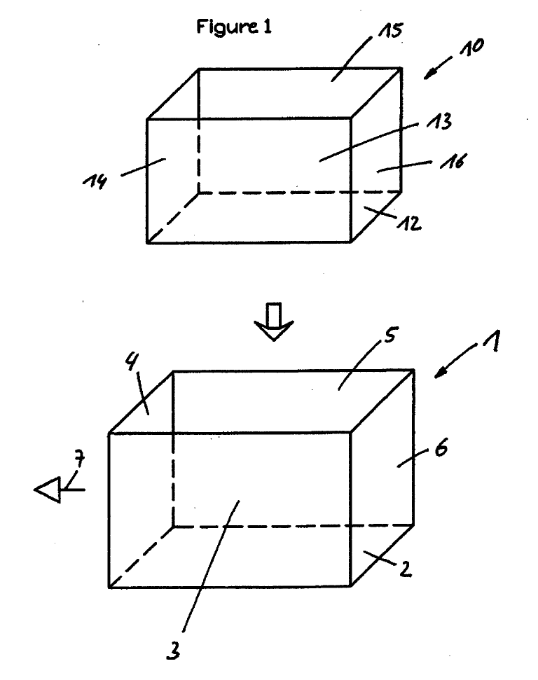

The residue container 1 shown in FIG. 1 has a base 2 and side walls 3-6. The residue container 1 is inserted in the direction of the arrow 7 into the region of a coffee machine provided for the purpose.

Beforehand, however, the residue container is equipped with an insert 10 of absorbent material for absorbing the moisture contained in the coffee grounds. In the embodiment shown, the insert 10 likewise comprises a base 12 and side walls 13-16, the height of the insert 10 corresponding ap proximately to the height of the residue container 1, so that the insert 10 lines the residue container 1 completely.

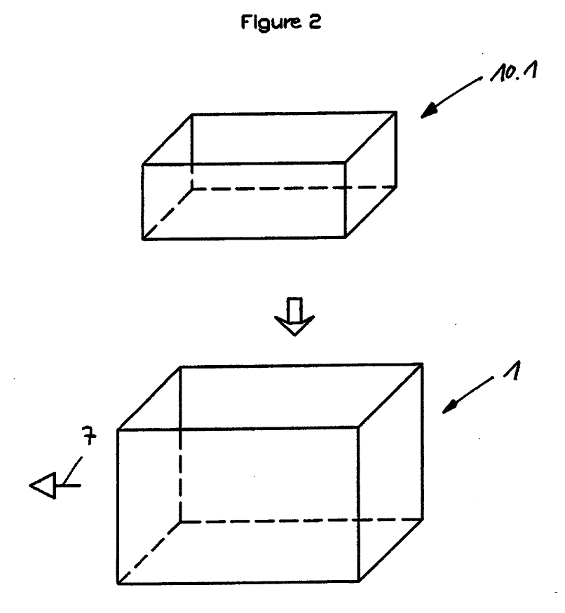

In the variant shown in FIG. 2, the insert 10.1 is not as tall, so that the residue container 1 is only partially lined.

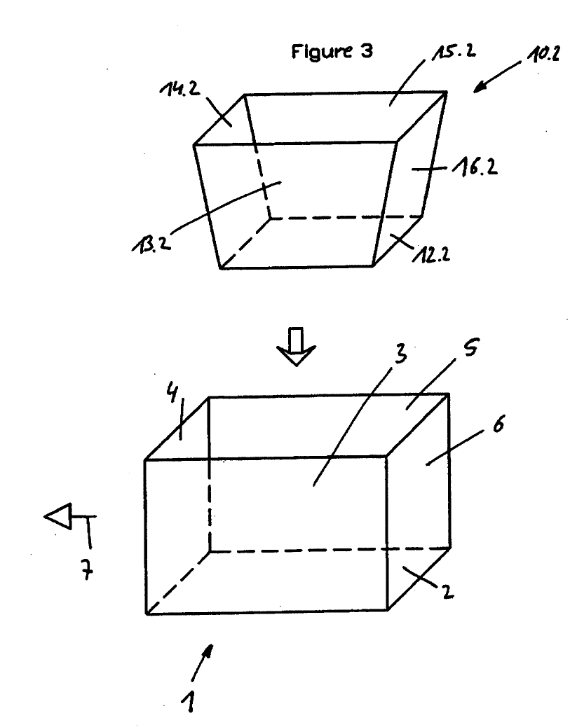

While the side walls of the insert according to FIGS. 1 and 2 are oriented perpendicularly to the base, the insert 10.2 according to FIG. 3 is constructed with inclined walls, so that the insert 10.2 tapers towards the bottom. This gives rise to cavities between the side walls 3-6 of the residue container 1 and the side walls 13.2-16.2 of the insert 10.2, so that the insert does not abut the side walls of the residue container directly. That construction prevents the residue container 1 from becoming soiled and also permits better drying of the insert.

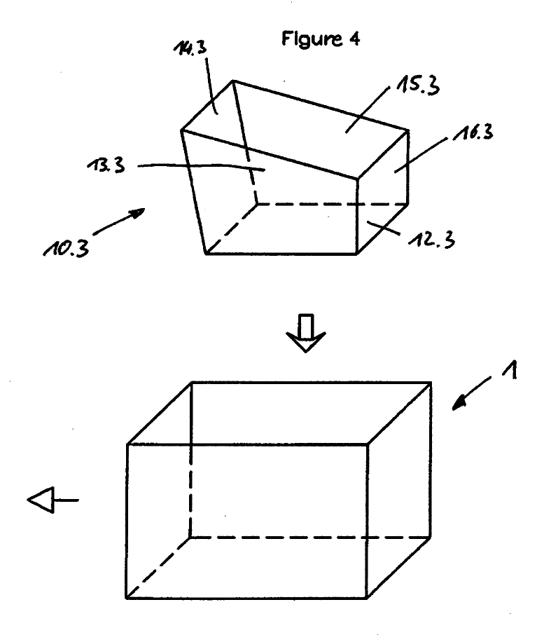

FIG. 4 shows an insert 10.3 which differs from the insert 10.2 in that the height of the side wall 16.3 is lower than the height of the opposite side wall 14.3.

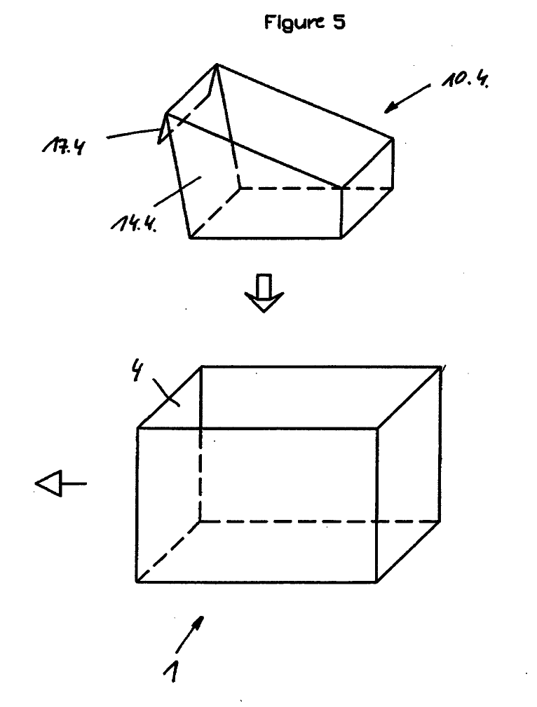

FIG. 5 shows a development of the insert according to FIG. 4. The insert 10.4 has, on the higher side wall 14.4, a suspension flap 17.4 by means of which it can be suspended from the upper edge of the side wall 4 of the residue container 1. That measure prevents the insert from inadvertently slipping down.

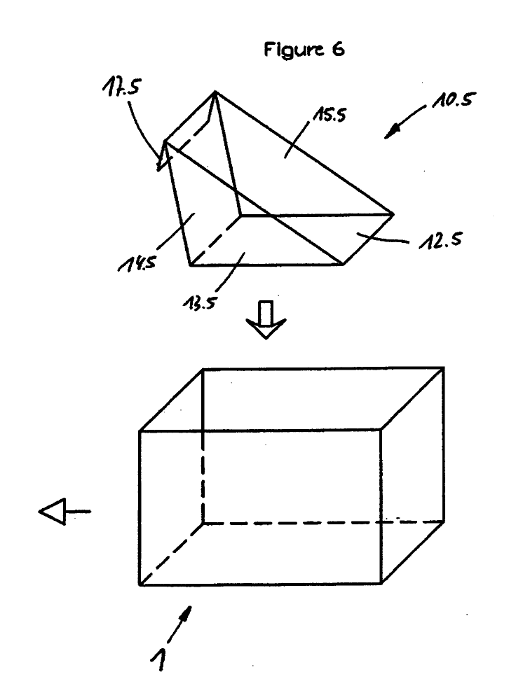

The insert 10.5 according to FIG. 6 likewise provides a suspension flap 17.5. Otherwise, however, it has only three side walls 13.5 to 15.5. The side walls 13.5 and 15.5 are therefore triangular.

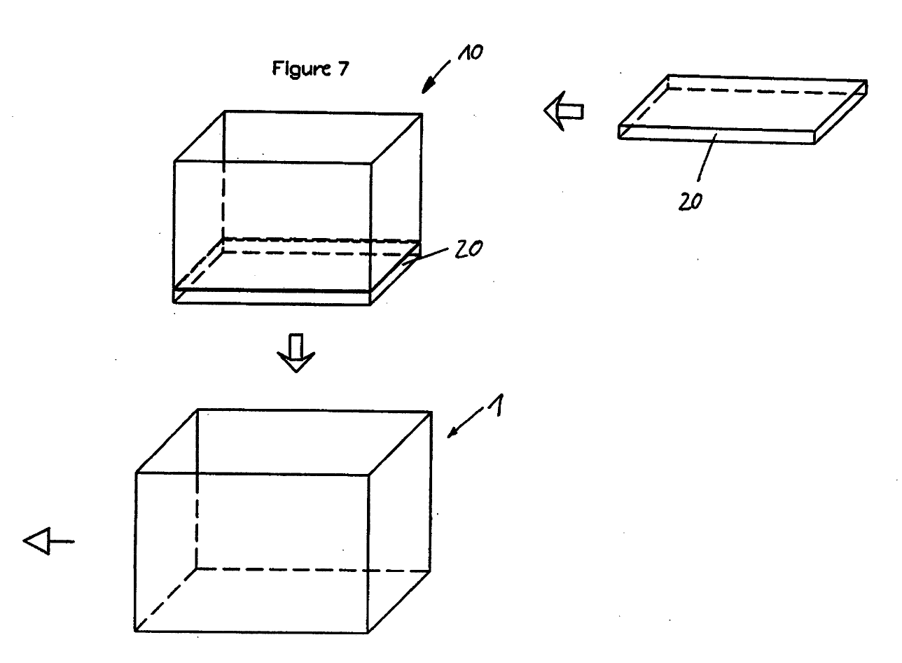

The embodiment according to FIG. 7 corresponds substantially to the variant shown in FIG. 1. However, the insert 10 also has a further, auxiliary, absorbent insert 20 which is introduced into the insert 10 in order to increase absorbency for the fluid located in the coffee grounds.

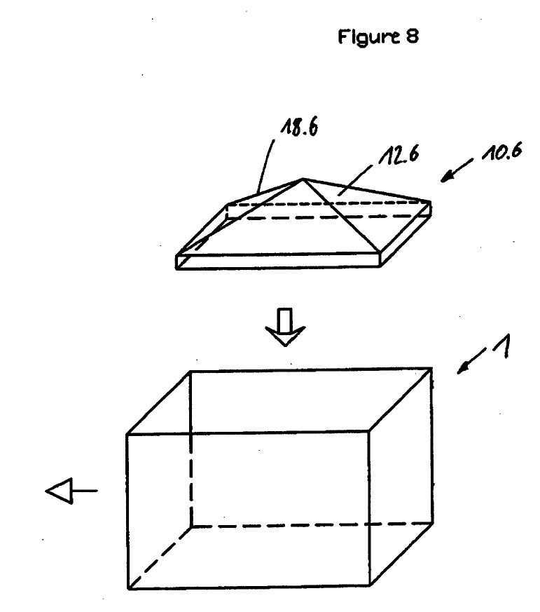

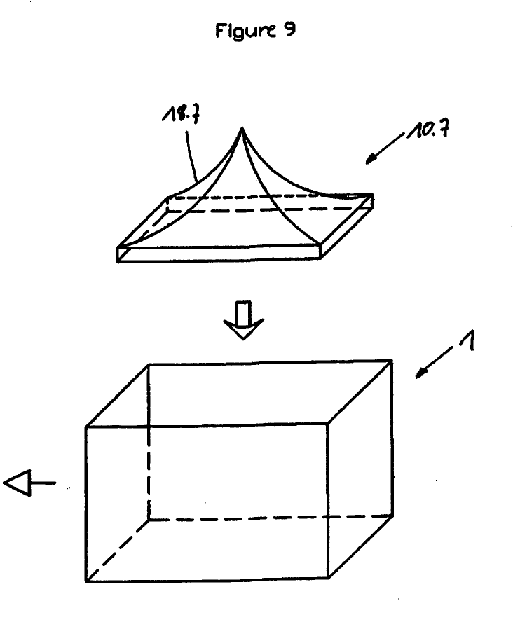

The insert 10.6 according to FIG. 8 is formed by an insert base 12.6 which is constructed in a pyramid like manner. The edges 18.6 of the pyramid are linear while the embodiment according to FIG. 9 shows an insert 10.7 having curved pyramid edges 18.7.

The insert 10.8 according to FIG. 10 is a combination of the insert 10.4 according to FIG. 5 and a pyramid like base 17.6 according to FIG. 8.

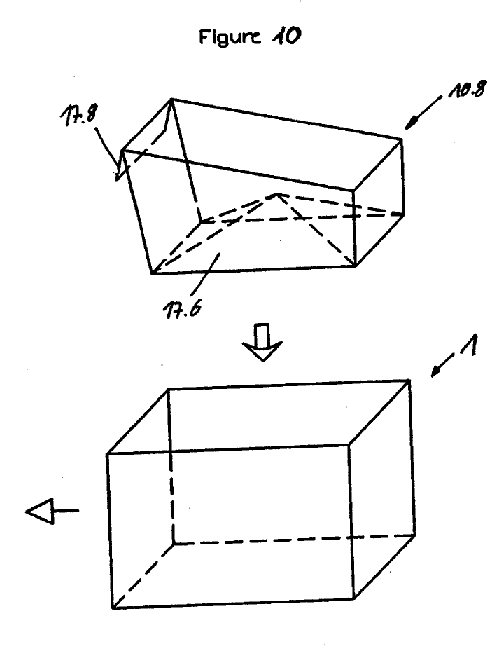

Within the scope of the invention, it is of course also possible to provide several suspension flaps. The insert 10.9 according to FIG. 11 accordingly shows suspension flaps 17.9 on all four side walls. If the heights of two side walls differ, as in the embodiment shown, the base 12.9 of the insert 10.9 is oriented in an inclined manner with respect to the base 2 of the residue container 1.

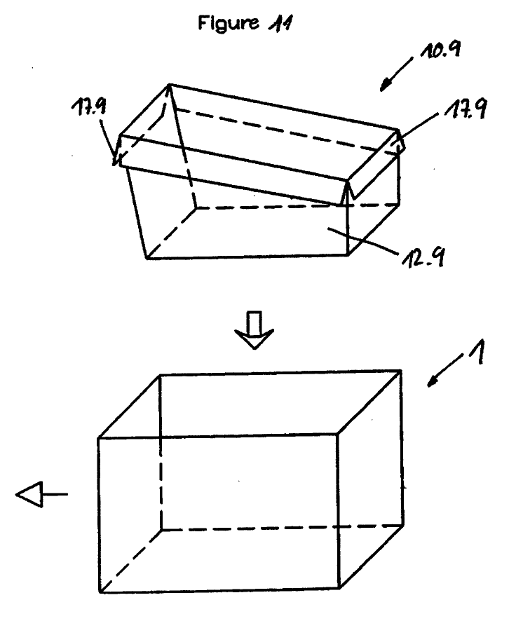

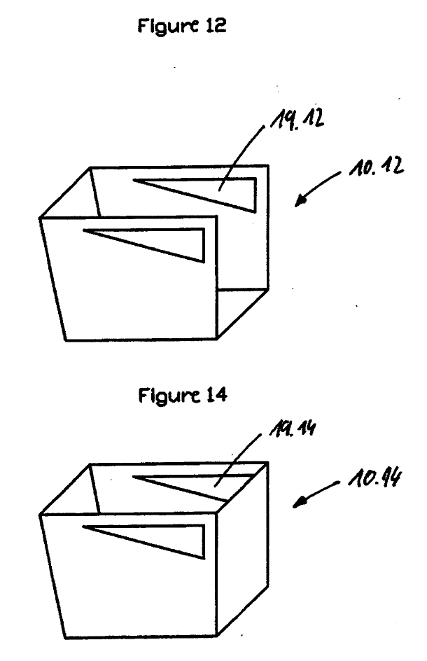

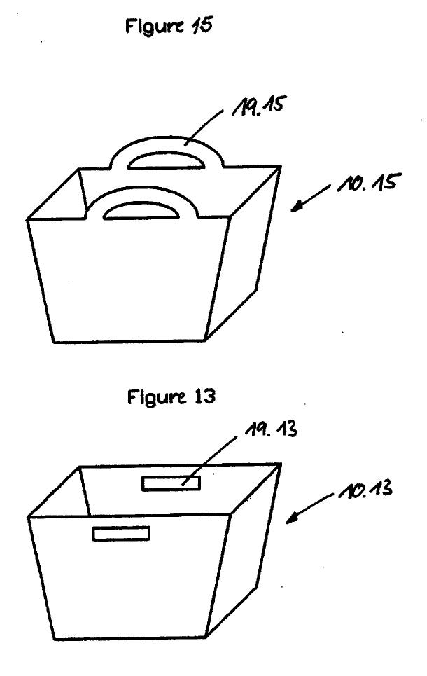

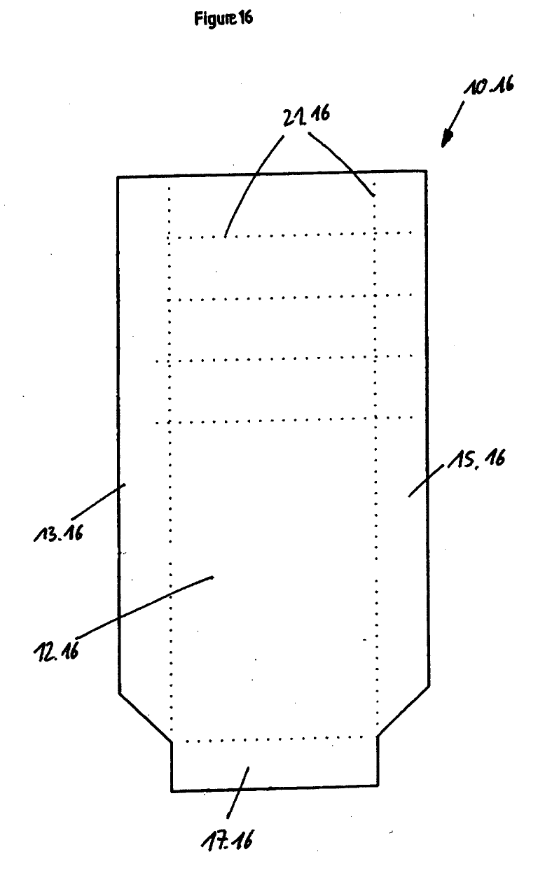

FIGS. 12 to 15 show various inserts 10.12 to 10.15 having carrying elements 19.12 to 19.15 in the form of handles which are to facilitate the removal of the insert filled with coffee grounds. The carrying elements may be in the form of openings (19.12 to 19.14) in two side walls or may be in a handle like form (19.15).

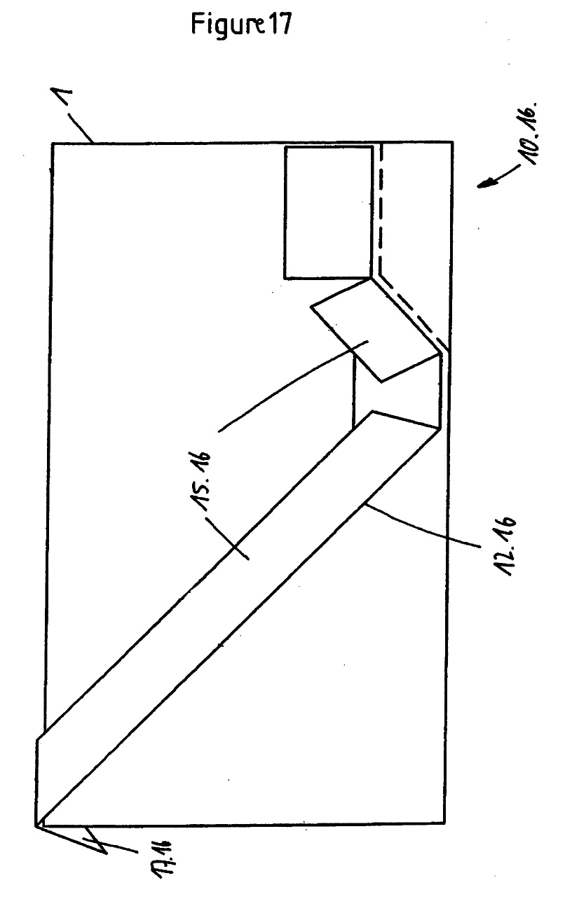

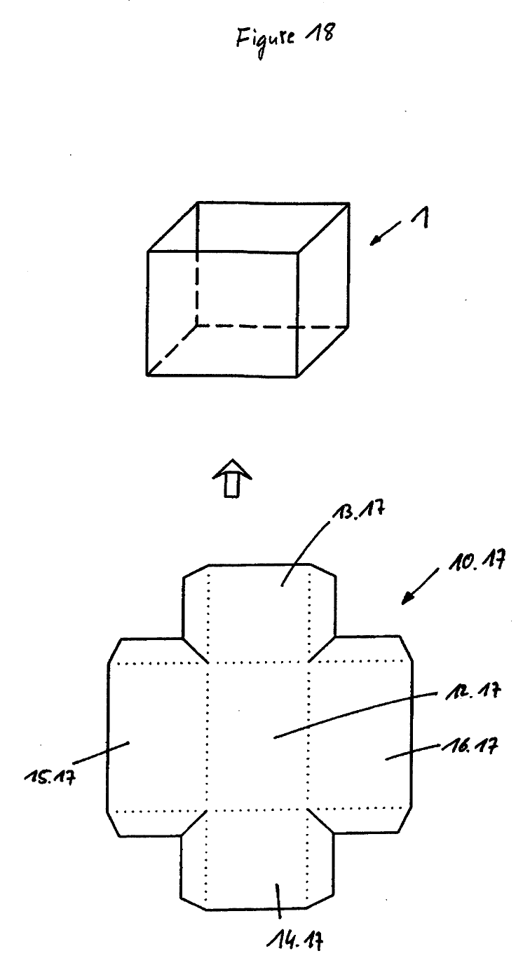

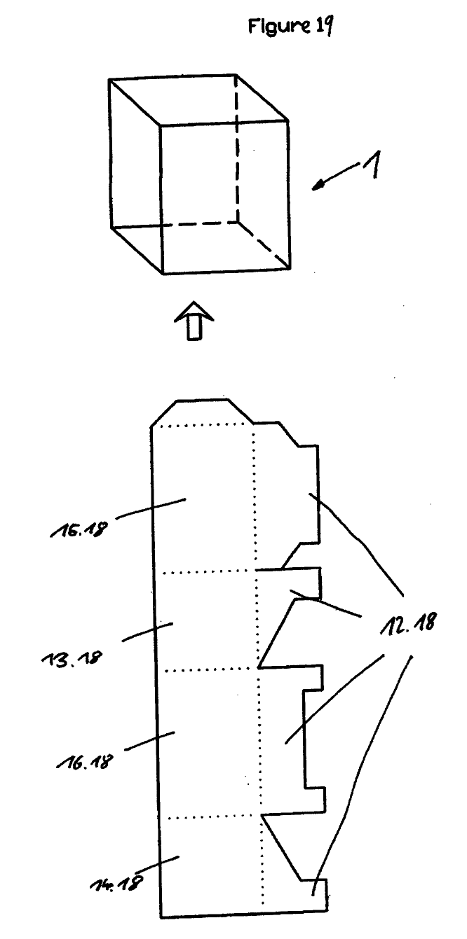

The inserts are preferably manufactured from a flat material blank. FIG. 16 shows a corresponding material blank for the insert 10.16 shown in FIG. 17. Perforation lines 21.16 facilitate the production of the correct form, the base 12, 16, the side walls 13.16, 15.16 and the suspension flap 17.16 being formed. In order to ensure that the inserts can be used for various container sizes and types, additional perforation lines may be arranged in the insert.

The insert 10.17 according to FIG. 18 is likewise formed from a flat material blank, overlapping occurring in the region of the side faces (13.17 to 16.17).

The material blank according to FIG. 19 is in a form such that the overlaps are provided in the region of the base 12.18. As a result, absorbency is increased precisely where it is especially needed.

In principle, synthetic or natural materials, such as paper, blotting paper, cardboard, sponge, non-woven fabric, cotton wool and/or textiles, and materials composed of vegetable starch come into consideration as absorbent material for the inserts. Biologically degradable material is especially preferred.

Materials that have been enhanced by coating, wetting, soaking and/or vapor blasting the insert with absorbents also come into consideration. In addition, it is possible to treat the insert with an acidic medium because mould formation is hindered in the surrounding acidic area.

In addition to the suspension flap described in some embodiments, it is of course also possible to provide other securing means, such as clamping elements. However, the insert is advantageously so constructed and fixed that it falls out easily by rotation of the residue container or can be removed by manual action.

1. A residue container (1) for a coffee machine, characterized in that the container has an insert (10) of absorbent material for absorbing the moisture contained in the coffee grounds.

2. A residue container according to claim 1, characterized in that the insert is folded from a flat material blank (10.16, 10.17, 10.18).

3. A residue container according to claim 1, characterized in that the insert (10.12, 10.13, 10.14, 10.15) is constructed in the manner of a bag.

4. A residue container according to claim 1, characterized in that the insert (10.4) can be secured to at least one edge region of the residue container (1).

5. A residue container according to claim 1, characterized in that the insert (10) lines at least partially a base (2) and/or at least one wall (3, 4, 5, 6) of the container.

6. A residue container according to claim 1, characterized in that the insert (10.6, 19.7) is disposed on the base of the container and has a pyramid like shape.

7. A residue container according to claim 1, characterized in that the insert (10) is composed of biologically degradable material.

8. A residue container according to claim 1, characterized in that the insert (10) is treated with an acidic medium.

9. A residue container according to claim 1, characterized in that the insert (10.15) has carrying elements (19.15), especially handles.

10. A residue container according to claim 1, characterized in that the insert (10.16, 10.17, 10.18) is folded from a flat material blank, perforation lines (21.16) or the like predetermining the folding edges.

11. A residue container according to claim 1, characterized in that the insert (10.4) has fixing means (17.4) in order to secure the insert to the container.

12. A residue container according to claim 1, characterized in that printing can be provided on the insert (10).

13. A residue container according to claim 1, characterized in that an auxiliary insert (20) is provided in the insert (10) in order to increase absorbency.

14. A residue container according to claim 1, characterized in that the insert (10.2) covers at least one wall of the container (1), the insert being arranged in an inclined manner with respect to that container wall.

15. A residue container according to claim 1, characterized in that the insert (10.2) is so constructed and arranged that at least one cavity is formed between the insert and the container.
